(19) United States
(12) Patent Application Publication
(10) Pub. No.: US 2002/0085708 A1
(43) Pub. Date: Jul. 4, 2002

(54) Apparatus comprising a display screen

(76) Inventor: Nicolas Ringot, Le Mans (FR)

Correspondence Address: Corporate Patent Counsel, U.S. Philips Corporation, 580 White Plains Road, Tarrytown, NY, 10591, US

(21) Appl. No.: 09/999,371

(22) Filed: Oct. 31, 2001

(30) Foreign Application Priority Data
Oct. 31, 2000 (FR) 0013986

(51) Int. Cl. H04M 1/00; H04M 9/00; H04B 1/38

(52) U.S. Cl. 379/433.04; 455/90

(57) ABSTRACT

This apparatus comprises a housing (1) on which is arranged a display screen (3) for displaying short menus and/or data and controls (10) for changing the display.

The invention proposes to provide at least a display control (20) placed on the side of the housing opposite the screen (3). Thus it is possible to save place on the front face in view of allowing for the largest possible space for the screen (3).

Mobile radio telephony.

The invention relates to an apparatus comprising a housing on which a display screen is arranged for displaying short menus and/or data and controls for modifying the display.

The invention finds interesting applications when a great many data are to be displayed on a screen of small dimensions, thus mounted on an apparatus having small dimensions itself too. This is notably the case when the apparatus is a mobile radio telephone which one wishes to make the least cumbersome, whereas people want to have an ever larger screen.

An apparatus of this type, comprising a screen and a plurality of controls is known from U.S. Pat. No. 5,774,540. This patent provides no solution whatsoever for obtaining both a large screen and a small housing.

The present invention proposes an apparatus of the type defined in the opening paragraph which makes it possible to save place on the housing and thus to save a large enough place for the screen without this becoming too cumbersome.

For this purpose, such an apparatus is characterized in that it comprises at least a display control placed on the side of the housing opposite the screen.

These and other aspects of the invention are apparent from and will be elucidated, by way of non-limitative example, with reference to the embodiment(s) described hereinafter.

In the drawings:

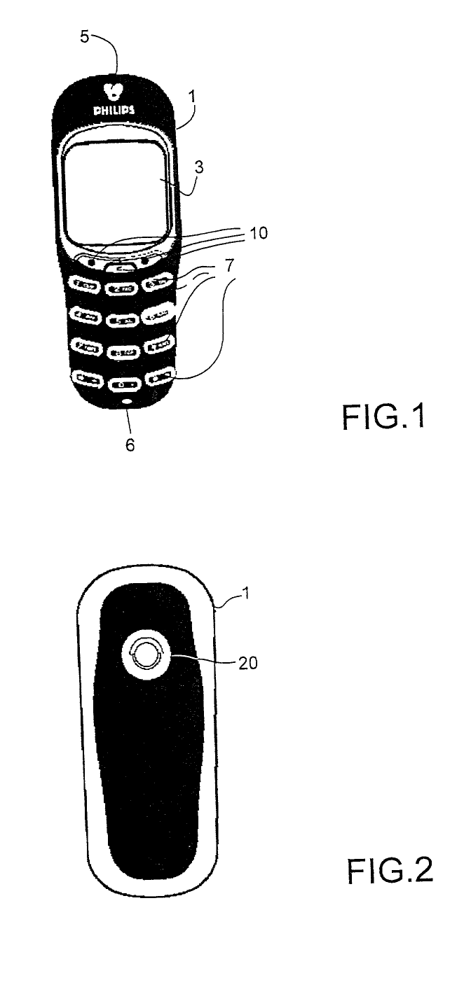

FIG. 1 shows a front view of the apparatus according to the invention,

FIG. 2 shows a back view of the apparatus according to the invention,

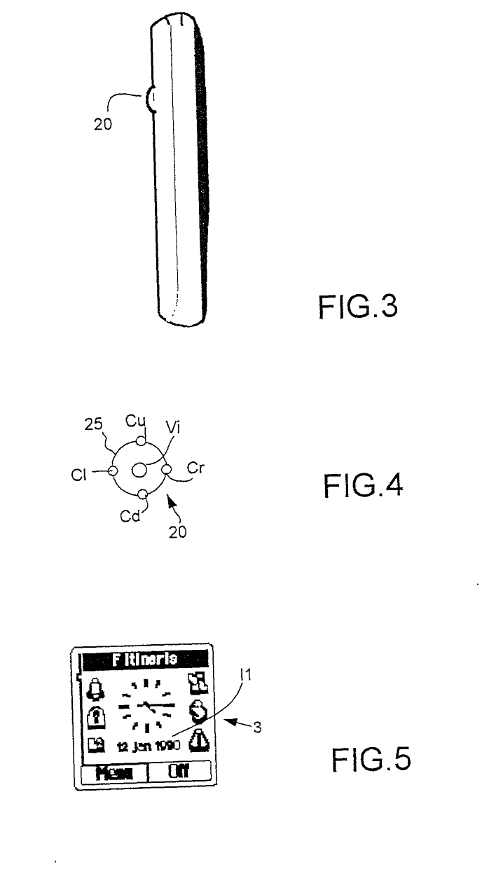

FIG. 3 shows a side view of the apparatus according to the invention,

FIG. 4 shows the arrangement of the control recommended by the invention,

FIG. 5 shows an example of an image displayed by an apparatus according to the invention, and

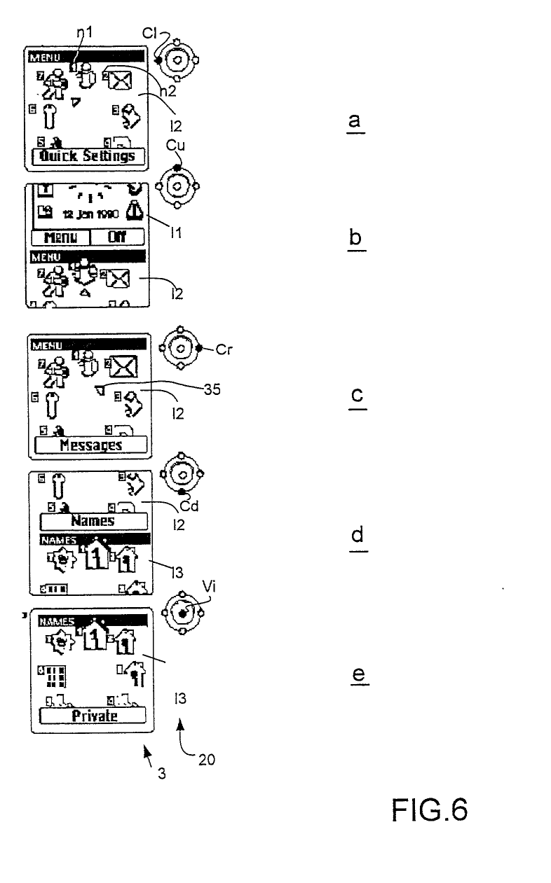

FIG. 6 shows how the navigation is organized on an apparatus according to the invention.

In FIG. 1 is represented a mobile telephone formed by a housing 1 notably comprising a screen 3, a loudspeaker 5, a microphone 6, a keypad 7 and a set of menu keys 10.

According to the invention a control has been provided on the back of the apparatus, on the side of the housing opposite the screen. FIG. 2 shows the back view of the housing on which the control 20 is shown. Thus, by operating this control it is possible to navigate among the short menus displayed on the screen 3.

This control 20 forms a protuberance on the back of the apparatus as is shown in FIG. 3. Thus, the user has no problem operating this control 20 because he feels under his fingers this protuberance which guides his movements.

This control 20 is formed by five contacts of which four: <<Cu>>, <<Cd>>, <<Cl>> and <<Cr>> are situated on the circumference of a ring 25 and a fifth <<Vi>> is situated in the center of this ring 25, as this is shown in FIG. 4.

With this control 20 it is possible to execute a navigation in a data set to be displayed. Image <<I1>> shown on the screen 3 in FIG. 5 is started from. This navigation is explained with the aid of FIG. 6.

Starting from image I1, shown in FIG. 5, by pressing the control 20 which acts on the contact <<Cl>>, an image 12 is made to appear by scrolling, which image relates to the previous screen already accessed; This is shown at a in FIG. 6. This screen is, for example, of the type described in patent document EP 0 944 218 filed in the name of the applicants on Mar. 16, 1999. This document proposes a screen on which icons are shown in a circle. By pressing a key, these icons are rotated.

By acting on the contact <<Cu>>, the previous screen is scrolled, that is to say, image <<I1>>. If the contact <<Cr>> is acted on, the next option is accessed, which is indicated by the arrow 35. Acting on the contact <<Cd>> causes another scrolling of the screen. If the contact <<Vi>> is acted on, the selected option is validated. For example, arrow 35 pointing at an item of a menu represented by an icon indicates the option that may be validated.

It is possible to combine this navigation which one wishes to qualify in analogy with the control means 20 with a direct navigation obtained by means of the keys of the keypad 7. Thus, if reference is made to FIG. 6, one sees in image 12 that various digits n1, n2, . . . are put opposite the displayed icons.

According to analogical navigation, the function suggested by the icon may be validated when the function is put facing the arrow 35 by rotating the icon carousel shown in image 12. To obtain this one acts in the manner indicated in the text of European patent mentioned above. Once the icon is facing said arrow, the contact <<Vi>> is pressed.

According to direct navigation, various numbers (or other references) <<n1>>, <<n2>>, . . . , and so on are assigned to the items of the menu displayed on the screen 3. One key of the keyboard is pressed which key is provided with the number corresponding to the selected item. The data relating to the icon or item referred to in this manner appears on the screen 3 without scrolling. The pressing of the key concerned of the keypad 7 may be validated by pressing another key <<Tv>>, which forms part of the key assembly 10 (see FIG. 1).

Thus one understands that the invention brings many advantages:

The main advantage, as it has been said, is that the cumbersomeness is reduced without sacrificing the dimensions of the screen,

A second advantage is that one has a mixed navigation mode which enables fast navigation in the direct mode,

This mixed navigation mode permits to be adapted to the mentality of the users,

Furthermore, the invention may be used for <<Internet>> navigation or, more precisely, <<WAP>>.

1. An apparatus comprising a housing on which a display screen is arranged for displaying short menus and/or data and controls for modifying the display, characterized in that it comprises at least a display control placed on the side of the housing opposite the screen.

2. An apparatus as claimed in claim 1, characterized in that this control permits to scroll various items on said screen.

3. An apparatus as claimed in claim 1 or 2, comprising a keypad, characterized in that it offers two kinds of navigation, one called analogical navigation obtained by means of said display control and one called direct navigation obtained by pressing keys of the keyboard which correspond to a marker relating to the items of the displayed menu.
